(19) United States
(12) Patent Application Publication
(10) Pub. No.: US 2017/0043374 A1
(43) Pub. Date: Feb. 16, 2017

(54) DOUBLE LAYER COATING FOR LIGHTING FIXTURE

(71) Applicant: GE Lighting Solutions, LLC, East Cleveland, OH (US)

(72) Inventors: Jon Bennett JANSMA, Pepper Pike, OH (US); Jianmin HE, Orange, OH (US); Dengke CAI, Willoughby, OH (US)

(21) Appl. No.: 14/822,933

(22) Filed: Aug. 11, 2015

(51) Int. Cl. B05D 7/00; C09D 5/28; B05D 3/04; C09D 5/33; B05D 5/06; B05D 5/02

(52) U.S. Cl. CPC B05D 7/5483; B05D 5/063; B05D 5/02; B05D 7/544; B05D 3/0406; C09D 5/004; C09D 5/28; C08K 2003/2241

(57) ABSTRACT

Provided is a double layer coating for a lighting fixture and method that includes a first coating layer of a reflective material disposed on an outer metal layer of the lighting fixture, and a second coating layer disposed on the first coating layer and providing a matte external reflective surface for the lighting fixture. The binder content of the first coating layer is higher than the binder content of the second coating layer.

### TECHNICAL FIELD

The present invention relates generally to a lighting fixture. In particular, the present invention relates a double layer coating method for a lighting fixture.

### BACKGROUND

A lighting fixture is designed to direct light to provide efficient illumination of objects or surface areas. An important component of the lighting fixture is a reflective metal which provides directivity of the light produced by the light sources. The lighting fixture includes a base metal material which is typically coated with a reflective layer to provide visible light reflectivity and to protect the metal material from the environment.

The reflective layer is often applied as an adhesive film or as a single coating layer via a thermal or ultraviolet (UV) curing process. Solvent borne coatings are also used as a single layer. The use of thermal or UV curing processes may result in a high gloss coating. Efficient total reflectivity and low gloss can be difficult to achieve with a single coating layer.

In light emitting diode (LED) applications, it is often desirable to achieve a low gloss coating in order to prevent the appearance of individual LED devices as reflected from the fixture surface. Therefore, in existing LED applications, implementation of thermal or UV curing processes fails to result in a desired low gloss coating on the lighting fixture.

### SUMMARY

Given the foregoing deficiencies, a need exists for a double layer coating for a lighting fixture. Particularly, methods are needed for forming the double layer coating for light reflection in lighting fixtures (i.e., LED lighting fixtures), to produce the desired low gloss coating without using a curing or thermal process.

In one exemplary embodiment, a double layer coating for a lighting fixture is provided. The double layer coating for a lighting fixture includes a first coating layer of a reflective material disposed on an outer metal layer of the lighting fixture, and a second coating layer and disposed on the first coating layer and forming a matte external surface for the lighting fixture. A binder content of the first coating layer is higher than a binder content of the second coating layer.

In another exemplary embodiment, a double layer coating for a lighting fixture is provided. The double layer coating for a lighting fixture includes a first coating layer of a reflective material disposed on an outer metal surface of the lighting fixture; and a second coating layer of a matte material disposed on the first coating layer. A pigment volume concentration of the first coating layer is lower than that of the second coating layer.

In another exemplary embodiment, a double layer coating method for a lighting fixture is provided. The method includes disposing a first coating layer of a reflective material formed by a liquid on an outer metal surface of a lighting fixture, and drying the first coating layer, and disposing a second coating layer of a matte material formed by a liquid on the first coating layer, and drying the second coating layer. A binder content of the first coating layer is higher than a binder content of the second coating layer.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### BRIEF DESCRIPTION OF THE DRAWINGS

FIG. 1 is a schematic illustrating a double layer coating for a lighting fixture that can be implemented within one or more embodiments of the present invention.

FIG. 2 is a flow diagram for a double layer coating method that can be implemented within one or more embodiments of the present invention.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Embodiments of the present invention provide a double layer coating for a lighting fixture includes first coating layer and a second coating layer. These layers have properties that can be separately adjusted based on the level of reflectivity and gloss needed. The double layer coating of the present invention may provide a high total reflectance while maintaining a low gloss appearance, without performance of any special curing or thermal processes. It may be implemented within various types of lighting fixtures to provide efficient illumination of display and surface areas.

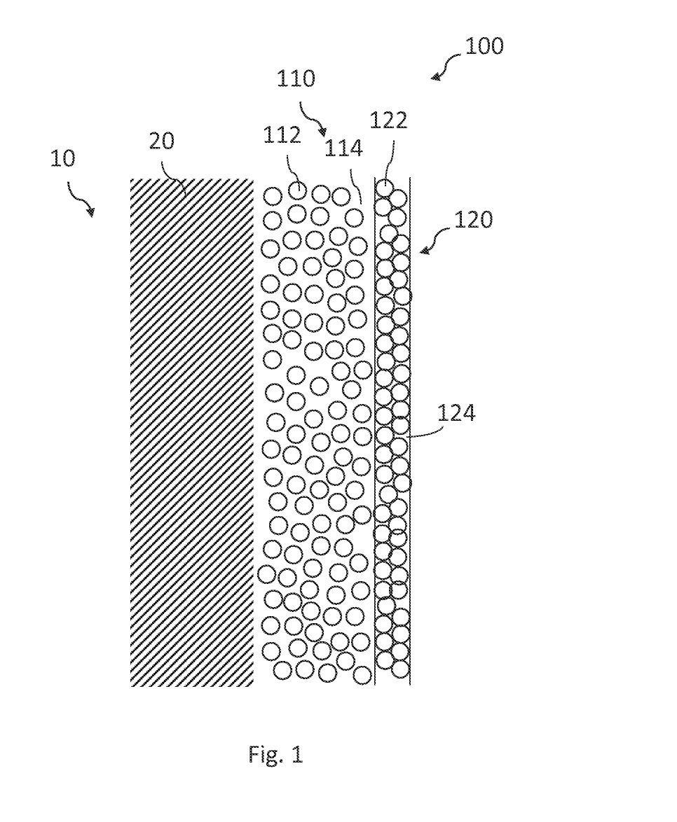

FIG. 1 is a schematic illustrating a double layer coating 100 for a lighting fixture 10 that can be implemented within one or more embodiments of the present invention. As shown, the double layer coating 100 is formed on an outer metal layer 20 of the lighting fixture 10. The double layer coating 100 includes a first coating layer 110 and a second coating layer 120. Both the first coating layer 110 and the second coating layer 120 are formed of a liquid material and subsequently dried, via a drying process.

The first coating layer 110 is disposed on the outer metal layer 20 of the lighting fixture 10. The first coating layer 110 is formed of particles 112 having a high refractive index (i.e., a refractive index greater than 1.5) and a binder 114. The particles 112 may be formed of a material such as Titania (e.g., anatase or rutile Titania), Alumina, Zirconia or silica.

According to one or more embodiments, the particles 112 are of a spherical shape, and are monodispersed. That is, the particles 112 are of uniform size in a dispersed phase. These particles 112 are free from defects and impurities. The particles 112 have a median size that is specified to emphasize a particular reflectance. For example, the particle size may emphasize a reflectance from blue and red visible wavelengths of light emitted from a lighting source (e.g., LEDs).

The binder 114 of the first coating layer 110 may be a transparent liquid binder possessing a lower refractive index than that of the particles 112. For example, the binder 114 may include a refractive index typical of acrylic or silicone type binders. Many types of polymeric binders would be suitable for the purposes set forth herein.

According to an embodiment, a critical coating design parameter is the pigment volume content (PVC). The PVC is defined as a ratio of the volume of the particles 112 to the volume of the binder 114 in the first coating layer 110. The critical PVC (CPVC) point exists where the volume of the binder 114 is sufficient only to fill voids formed between the particles, as shown in FIG. 1. The volume fraction of the particles 112 (or PVC) of the first coating layer 110 is therefore less than the CPVC, to provide sufficient adhesion and total reflectance. The CPVC varies for different pigment binder combinations and is between PVC values of approximately 0.4 and approximately 0.6. Once the CPVC is determined for a given pigment and binder design, then a PVC can be selected either above or below the CPVC. For example, the first coating layer 110 may include a PVC=0.3 while the second coating layer may include a PVC=0.7. Factors such as adhesion and wear are considered to optimize the PVC values.

According to the embodiments, the second coating layer 120 is disposed on the first coating layer 110.

The second coating layer 120 is formed of particles 122 and binder 124. The particles 122 can be spherical in shape but are not uniformly spaced from each other. Further the particles 122 can be overlapping and polydispersed in comparison to the particles 112 of the first coating layer 110. The particles 122 are formed of Titania (e.g., anatase or rutile Titania), Alumina, Zirconia or silica or some other types of material similar to or different from that of the particles 112 of the first coating layer 110.

According to another embodiment, the particles 112 of the first coating layer 110 can be formed of anatase Titania and the particles 122 of the second coating layer 120 may be formed of rutile Titania. Further, the particles 122 can be formed of the same size and shape as that of the particles 112, however the present invention is not limited hereto. The particles 112 and 122 may be of different sizes and shapes in accordance with alternative embodiments. The second coating layer 120 provides a matte finish without the loss of the reflective properties of the first layer.

The volume fraction (or PVC) of the particles 122 of the second coating layer 120 is greater than or equal to the CPVC, to minimize gloss and create a matte finish. For example, if the CPVC is 0.55, then the second coating layer 120 can include a PVC of approximately 0.7 or higher.

As further shown in FIG. 1, smaller voids are formed between the particles 122 of the second coating layer 120. The binder 124 is transparent and partially fills the voids between the particles 122.

The first coating layer 110 includes a higher binder content than that of the second coating layer 120. The second coating layer 120 includes less binder and thereby forms low gloss, matte external surface of the lighting fixture 10. The low gloss condition of the second coating layer 120 improves the appearance of the lighting fixture 10 when utilizing discrete LED devices.

The second coating layer 120 is a thin coating layer. The thickness of the first coating layer 110 is greater than the thickness of the second coating layer 120. The thickness of the first coating layer 110 may range from approximately 30 to 200 microns and the thickness of the second coating layer 120 may range from approximately 10 to 50 microns. The thicknesses of the first coating layer 110 and the second coating layer 120 may be adjusted separately to adjust coating performance for different lighting environments.

For example, in a warehouse or manufacturing plant, lighting fixtures may not require a low gloss appearance and therefore, the thickness of the first coating layer 110 may be adjusted to be significantly greater than that of the second coating layer 120, or the second coating layer 120 may be omitted. On the other hand, a retail or office environment may require a low gloss appearance, and therefore, the second coating layer 120 may be adjusted to be of a thickness which optimizes the matte finish behavior.

According to the embodiments, the double layer coating 100 involves a liquid coating application for both layers 110 and 120. Therefore, the first coating layer 110 and the second coating layer 120 may be disposed using a dip, spray or flow coating method followed by air-drying. The binder 114 or 124 may disposed and then the particles 112 or 122 may be added to the respective binder 114 or 124 when forming the respective first coating layer 110 or the second coating layer 120. The present invention, does not implement any special curing or thermal processes for forming the double layer coating 100.

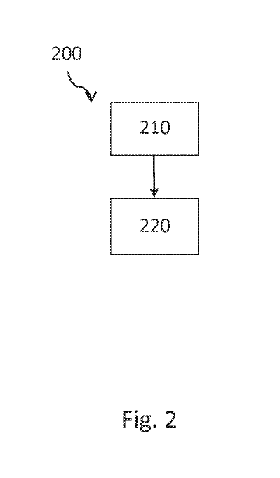

FIG. 2 is a flow diagram for an exemplary double layer coating method 200 that can be implemented within one or more embodiments of the present invention.

As shown in FIG. 2 with reference to FIG. 1, the method 200 begins at operation 210 where the first coating layer 110 is disposed on an outer metal layer 20 of a lighting fixture 10. As mentioned above, the first coating layer 110 may be disposed using a liquid coating operation, e.g., dip, spray or flow coating process followed by an air-drying operation.

From operation 210, the process continues to operation 220 where a second coating layer 120 is disposed on the first coating layer 110. The second coating layer 120 may be disposed using a similar liquid coating and air-drying operations as that of the first coating layer 110 performed in operation 210.

The first coating layer 110 includes a higher binder content than the second coating layer 120.

The thickness of the first coating layer 110 and the second coating layer 120 may be separately adjusted during manufacturing based on the lighting environment as discussed above. When high reflectance is desirable, the thickness of the first coating layer 110 may be significantly greater than that of the second coating layer 120, and when low gloss is desirable, the thickness of the second coating layer 120 may be more comparable to that of the first coating layer 110.

Embodiments of the present invention provide the advantages of forming a double layer coating on a lighting fixture without any special curing or thermal processes and controlling the reflectivity and gloss of the appearance of the lighting fixture by controlling the PVC of the first and second coating layers of the double layer coating, and separately adjusting the thickness of the first and second coating layers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A double layer coating for a lighting fixture, comprising:
a first coating layer of a reflective material disposed on an outer metal layer of the lighting fixture; and
a second coating layer disposed on the first coating layer and forming a matte external surface of the lighting fixture, wherein a binder content of the first coating layer is higher than a binder content of the second coating layer.

2. The double layer coating of claim 1, wherein a thickness of the first coating layer is greater than a thickness of the second coating layer.

3. The double layer coating of claim 1, wherein the first coating layer comprises a plurality of particles having a refractive index greater than 1.5, and the binder content thereof.

4. The double layer coating of claim 3, wherein the particles are formed of a material comprising at least one of Titania, Alumina, Zirconia or Silica.

5. The double layer coating of claim 3, wherein the particles are monodispersed.

6. The double layer coating of claim 3, wherein the binder content of the first coating layer is a liquid transparent binder, having a refractive index less than the refractive index of the particles.

7. The double layer coating of claim 3, wherein a volume fraction of the particles of a pigment volume content of the first coating layer is less than a critical pigment volume content.

8. The double layer coating of claim 7, wherein the volume fraction of the particles is less than a volume fraction of the binder content in the first coating layer.

9. The double layer coating of claim 7, wherein the second coating layer comprises a plurality of particles having a refraction index greater than one, and the binder content thereof.

10. The double layer coating of claim 9, wherein the second coating layer is formed of a material comprises at least one of Titania, Alumina, Zirconia or Silica.

11. The double layer coating of claim 10, wherein one of the first coating layer or the second coating layer is formed of anatase Titania and the other of the first coating layer or the second coating layer is formed of rutile Titania.

12. The double layer coating of claim 9, wherein the particles of the second coating layer are overlapping and polydispersed.

13. The double layer coating of claim 9, wherein a volume fraction of the particles of a pigment volume content of in the second coating layer is greater than or equal to the critical pigment volume content.

14. The double layer coating of claim 13, wherein the volume fraction of the particles of the second coating layer is greater than a volume fraction of the binder content of the second coating layer.

15. A double layer coating for a lighting fixture comprising:
a first coating layer of a reflective material disposed on an outer metal surface of the lighting fixture; and
a second coating layer of a matte material disposed on the first coating layer, wherein a pigment volume concentration of the first coating layer is lower than that of the second coating layer.

16. The double layer coating of claim 15, wherein the pigment volume concentration of the first coating layer and the second coating layer are predetermined based on desired reflectivity and gloss appearance of the lighting fixture.

17. A double layer coating method comprising:
disposing a first coating layer of a reflective material formed by a liquid, on an outer metal surface of a lighting fixture, and drying the first coating layer; and
disposing a second coating layer of a matte material formed by a liquid, on the first coating layer, and drying the second coating layer, wherein a binder content of the first coating layer is higher than a binder content of the second coating layer.

18. The double layer coating method of claim 17, wherein a pigment volume concentration of the first coating layer is lower than that of the second coating layer.

19. The double layer coating method of claim 18, wherein the pigment volume concentration of the first coating layer and the second coating layer are predetermined based on desired reflectivity and gloss appearance of the lighting fixture.

20. The double layer coating method of claim 17, further comprises:
disposing of the first coating layer and the second coating layer by performing a liquid coating operation followed by an air-drying operation.

21. The double layer coating method of claim 18, wherein the pigment volume concentration of the first coating layer is less than the volume of the binder content thereof, and the pigment volume concentration of the second coating layer is greater than the volume of the binder content thereof.
